(19) United States
(12) Patent Application Publication
(10) Pub. No.: US 2003/0161143 A1
(43) Pub. Date: Aug. 28, 2003

(54) Portable and flexible light source

(76) Inventors: Herb Parker, Anna, TX (US); Melba Parker, Anna, TX (US)

Correspondence Address: Herb and Melba Parker, 3179 CR 427, Anna, TX, 75409, US

(21) Appl. No.: 10/373,177

(22) Filed: Feb. 24, 2003

Related U.S. Application Data
(60) Provisional application No. 60/359,764, filed on Feb. 26, 2002.

(51) Int. Cl. F21L 2/00

(52) U.S. Cl. 362/157

(57) ABSTRACT

Disclosed herein is my invention of a flexible and portable source of illumination, typically used to illuminate the interior surfaces and contents of a container, such as a purse and its contents. The device consists of a battery and case, a switch, an attachment clip and a clear, flexible tube that contains several small lights connected to each other as well as to the battery and switch. The length of lights can be flexibly arranged within the container so as to increase the level of ambient light throughout the entire interior volume of the container. The design presents an invention that is a standalone unit, not dependent on a container's shape, size or specific design. The invention can easily be removed from one container and positioned within another, allowing use of presently owned purses, for example.

### CROSS REFERENCE TO RELATED APPLICATIONS

This application claims the benefit of Provisional Patent Application Serial No. 60/359764 filed Feb. 26, 2002.

### STATEMENT REGARDING FEDERALLY SPONSED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND OF THE INVENTION

The conveyance of multiple personal articles is accomplished with a variety of containers, such as a purse, a hand bag, a shoulder bag, a back pack, a trunk, a briefcase, a gym bag, a duffel bag, a sport bag, a travel bag, a camera bag, a knapsack, etc. All of these generally consist of a chamber into which several articles of varying shape and size are placed. A person then transports the articles easily and collectively. A typical justification for collecting such articles into a container and using that container to transport the articles collectively is that the person transporting them has a need to use the articles in their daily life. A primary example of such is a purse, which enables the carrier to keep such items handy as facial cosmetics, currency, credit cards, check book, medication, photos, ‘to do’ or shopping lists, writing utensils, snacks, etc.

The variety in number and assortment of items typically stored and carried in these types of containers, such as a purse, foregoes the ability to arrange each item succinctly and repeatedly each time it is removed for use and subsequently replaced into the purse. Rather, each is loosely arranged in the purse in a haphazard manner, with primary concern only for the security of being contained wholly within the purse, but not in any particularly defined order or space arrangement. Each item is likewise of different and various shape and size. This variety of shapes, sizes and lack of typical repeatable arrangement complicates the ability to quickly and easily find all but the largest of items contained in such a manner. Locating a particular item is further exacerbated when sufficient light is not available, such as after dusk, or otherwise in a poorly lit space.

Class/sub-class 362/156 of the United States Patent Classification is reserved for inventions that pertain to the issue of illuminating containers, specifically a bag, purse or trunk. Prior art exists describing numerous devices and claims that address the issue of providing illumination to the inner chamber of a container such as a purse. Even so, room for improvement exists in the usability, functionality, performance and convenience of such a device over and beyond what prior art teaches.

Examples of such prior art include Coyner et al., U.S. Pat. No. 5,073,844 which claims a complete assembly of a baggage member and included source of illumination. In today's society it is not at all unusual that a person owns and uses several purses, each of different make, manufacturer, shape, size, color and appearance. Such variety and number of purses can and does indeed change constantly, as does the ownership of such variety and number of purses by any one individual. Coyner et al. does not adequately address this, claiming a combined baggage member and source of illumination. My invention is solely a source of illumination, which is portable between containers. This allows a person to quickly and easily provide illumination to any number of such purses by removing my invention from one purse and placing it into another.

Willis, U.S. Pat. No. 6,227,677 claims a rigid device which claims portability but which lacks the flexibility of my invention, thereby limiting the volume, surfaces and objects contained that can be simultaneously illuminated.

Zeller, U.S. Pat. No. 5,154,483 claims flexibility, but provides only a single directed and very focused illumination pattern, thereby failing to eliminate or significantly reduce the searching process undergone by a person desiring to locate a specific article in a container.

Cutler, U.S. Pat. No. 6,152,572 discloses a device that claims illumination, multiple sources of light and flexibility, but Cutler goes to great lengths to claim a device made immovable by attachment, preferable by stitching or sewing, to a container being illuminated. My invention further affords the ability not therein addressed nor claimed by Cutler of being able to transport a source of illumination from one container to another, whether the multiple containers be a different purse, backpack, etc. Cutler further does not afford the flexibility to arrange the source of illumination throughout the container being illuminated. Rather, Cutler provides and claims an immovable source of illumination, which by design depends entirely on the shape of the container being illuminated to direct the light onto the contained contents. It is not inconceivable that because of this dependency on the shape of the container, the illumination provided by Cutler's device might indeed be directed away from the inner chamber of the container, instead of inwardly as desired. Further, the length or size of Cutler's device is governed and limited by the size of the attached container, and specifically the length of the perimeter of the opening provided into the container. This then further negates the ability of the design to be utilized in a variety of containers, each of differing size and shape, and with differing construction regarding the opening provided into the container.

Norris, U.S. Pat. No. 6,099,140, Rivera, U.S. Pat. No. 5,444,605, Quintana et al. U.S. Pat. No. 5,934,790 and Myers, U.S. Pat. No. 5,424,926 each disclose devices that are generally fixed in their ability to direct the lighting, dependent on the shape of the container itself, lack the flexibility to arrange the source of illumination throughout the lighted compartment and are not easily transportable and useable in a multiplicity of containers, as provided in my invention.

### BRIEF SUMMARY OF THE INVENTION

Disclosed herein is my invention of a flexible and portable source of illumination. Accordingly, several objects and advantages of my invention are:

It is an independent standalone unit

It is independent of a container's shape, size and specific design or geometric features

It can be utilized in a wide variety of containers

It can be removed from one container and positioned within another

It does not influence the aesthetics or style of the user, in that it can be used in any container presently owned by the user

It is constructed of flexible material

It can be arranged in any manner of configuration

It consists of a plurality of lights for complete and widespread illumination

It increases the level of ambient lighting throughout the entire container

It provides illumination within and upon the interior surfaces of a container

It provides illumination directly on the articles contained within the interior of a container

Other objects and advantages of my invention are:

Low cost of manufacture

Ease of use

Use of common materials

Replaceable battery power supply

Aesthetically pleasing design

Further objects and advantages of my invention will become apparent from consideration of the ensuing description.

### BRIEF DESCRIPTION OF THE SEVERAL VIEWS OF THE DRAWING

FIG. 1 Preferred embodiment

FIG. 2 Section view of preferred embodiment, showing arrangement of components

FIG. 3 Electrical schematic of preferred embodiment

Reference Numerals in Drawing Figures

| | |
|---|---|
| 10 | Momentary Switch |
| 20 | Transparent Tube |
| 30 | Clip |
| 40 | Base Band |
| 50 | Top Band |
| 60 | Electrical Conductor |
| 70 | Lamp |
| 80 | Battery |
| 100 | End Cap |
| 110 | Battery Case |

### DESCRIPTION OF THE INVENTION

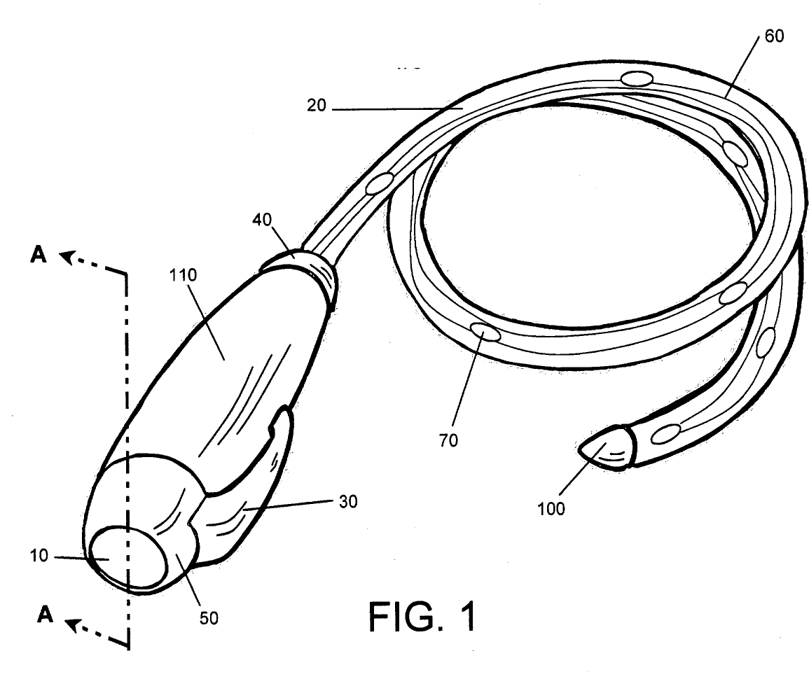

FIG. 1 shows the preferred embodiment of the Portable and Flexible Light Source.

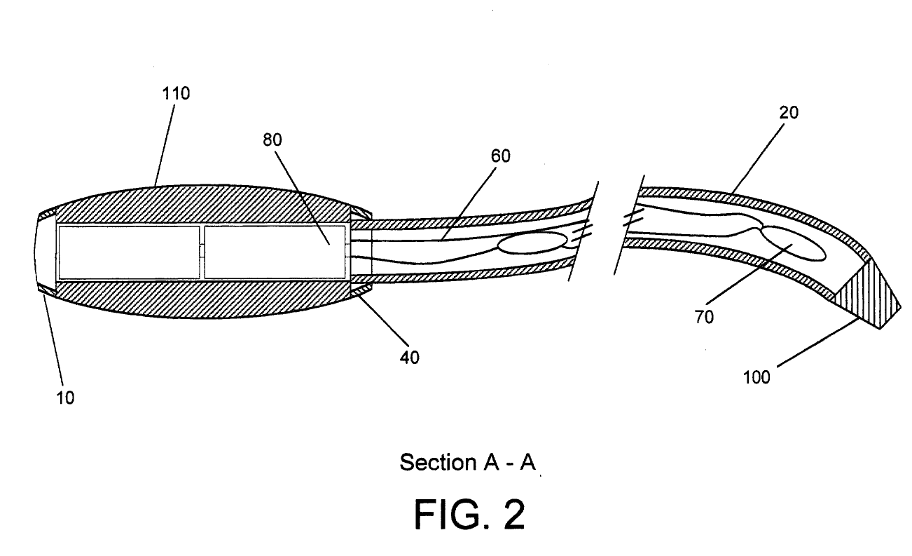

FIG. 2 is a Section View of the preferred embodiment, showing arrangement of the components

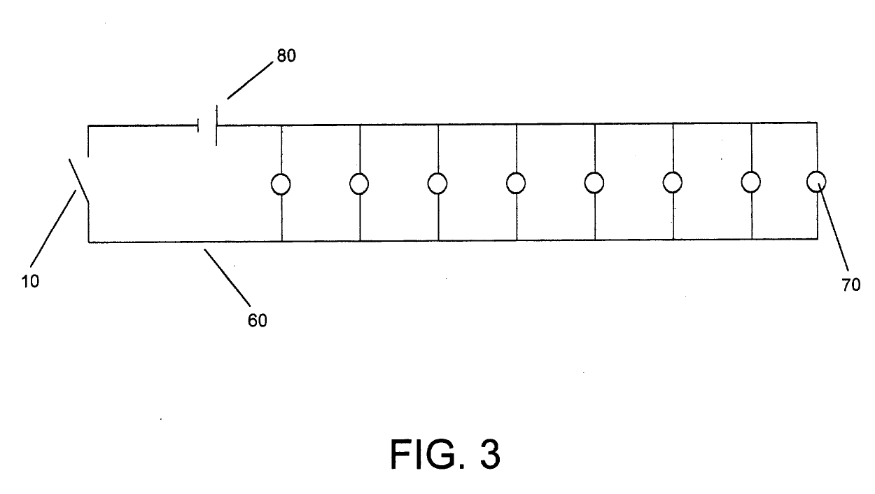

FIG. 3 is an Electrical Schematic of the preferred embodiment

FIG. 1 illustrates the preferred embodiment of the Portable and Flexible Light Source and shows a plurality of battery powered lights connected together by an electrical conductor. This set of lights is contained within and distributed along a length of transparent and flexible tubing. A controllable electrical switch is configured and attached at one end of a battery case, itself which is connected to the transparent and flexible tubing. Electrical power is supplied to the electrical circuit by a set of batteries contained within the battery case.

The lights, the switch and the battery are all connected electrically forming a parallel circuit. The electrical switch can be operated so as to control the supply of electrical power supplied by the battery to the plurality of lamps distributed within the transparent and flexible tubing. This electrical circuit also includes functionality to disconnect the electrical supply to the overall circuit following a predetermined length of time.

Further, there is a clip, or means of attachment, configured and attached at one end of the invention. This means of attachment can be used to secure the invention to an article that is to be illuminated by the invention.

Momentary Switch 10 is connected in parallel fashion electrically with Battery 80 and Lamps 70, using Electrical Conductor 60. Momentary Switch 10 is additionally connected to Battery Case 110 by Top Band 50.

Clip 30 is connected to Top Band 50 in close proximity to Momentary Switch 10. Transparent Tube 20 is connected to the opposing end of Battery Case 110 by Base Band 40.

Lamps 70 are connected in parallel electrical fashion to Electrical Conductor 60 in evenly spaced increments along the length of Electrical Conductor 60 so as to create electrical continuity. Electrical Conductor 60 and Lamps 70 are contained within and distributed along the length of Transparent Tube 20. Transparent Tube 20 is of sufficient inner dimension so as to effectively allow Electrical Conductor 60 and Lamps 70 to be distributed approximately evenly spaced throughout the length of Transparent Tube 20.

Battery 80 is contained within Battery Case 110, and is connected electrically to Momentary Switch 10 as well as to Electrical Conductor 60 so as to form a complete electrical circuit.

End Cap 100 is connected to the opposite end of Transparent Tube 20 from Battery Case 110.

To operate the Portable and Flexible Light Source, Momentary Switch 10 is manipulated to create electrical continuity between Electrical Conductor 60, Battery 80 and Lamp 70. Once Momentary Switch 10 is thus manipulated, the invention now produces light from Lamps 70, said light traveling through Transparent Tube 20 relatively unimpeded. This light can be used to illuminate objects and surfaces in the near proximity.

The invention can be placed inside an article, such as a purse, duffel bag, backpack, box or similar container, and flexibly arranged so as to illuminate the space and articles contained within.

The illumination produced by the invention ceases after a pre-determined time period following the manipulation of Momentary Switch 10. This auto-off feature prolongs the useful life of the battery.

The invention can be attached to a container using Clip 30. This will secure the invention in its position for repeated illumination use.

Top Band 50 can be removed from Battery Case 110 so that Battery 80 can be inserted into Battery Case 110. In the preferred embodiment of the Portable and Flexible Light Source, 2 standard AA 1.5 volt DC batteries are used.

Thus it can be seen that the Portable and Flexible Light Source provides a highly reliable, functional, practical and easy to use device. While my above description contains many specifics, these should not be construed as limitations on the scope of the invention, but rather as an exemplification of one preferred embodiment thereof. Many other variations are possible. Other embodiments and/or features of the Portable and Flexible Light Source include but are not limited to:

an on-off switch without an auto-off feature

the auto-off feature being over-rideable by the user of the invention

a battery case that also serves to secure the length of clear flexible tubing once the tubing is wrapped around it

an electrical circuit that has the components arranged in series rather than in parallel

end attachment means such as hook and loop strips (i.e.—Velcro™) or elastic straps that would allow the invention to be formed into an adjustable circular diameter, so as to aid in being attached to an article, for instance in the case of a jogger wrapping the invention around their arm

a variety of overall tubing lengths and included number of lamps

a variety of battery types and voltages

a variety of diameters for the tubing

a variety of colors and transparency for the tubing

a variety of colors and transparency for the lamps

a variety of degrees of flexibility in the tubing

Accordingly, the scope of the invention should be determined not by the embodiment illustrated, but by the appended claims and their legal equivalents.

What I claim as my invention is:

1) A means of illumination comprised of:
(a) A clear and flexible tube
(b) A plurality of lights
(c) A source of power
(d) A switch
(e) An electrical conductor
(f) An end plug for said clear and flexible tube
(g) Said plurality of lights electrically connected with said switch and with said source of power using said electrical conductor
(h) Said plurality of lights and said electrical conductor contained within and arranged equally along the length of said clear and flexible tube
(i) A containment means for said source of power
(j) A containment means for said switch
(k) An end plug for said clear and flexible tube
(l) Said clear and flexible tube connected to said containment means for said source of power
(m) Said switch connected to said containment means for said source of power
(n) Said end plug connected to said clear and flexible tube

2) The means of illumination described in claim 1 wherein said power source is replaceable.

3) The means of illumination described in claim 1 wherein said power source is rechargeable.

4) The means of illumination described in claim 1 wherein said switch becomes electrically discontinuous after a predetermined amount of time.

5) The means of illumination described in claim 1 further comprising an attachment means for attachment of the invention to a container being illuminated.
